(19) United States
(12) Patent Application Publication
(10) Pub. No.: US 2026/0236740 A1
(43) Pub. Date: Aug. 13, 2026

(54) CONTROLLING AGENTS USING Q-TRANSFORMER NEURAL NETWORKS

(71) Applicant: Google LLC, Mountain View, CA (US)

(72) Inventors: Yevgen Chebotar, San Francisco, CA (US); Quan Ho Vuong, Palo Alto, CA (US); Karol Hausman, San Francisco, CA (US); Fei Xia, Santa Clara, CA (US); Alexander Irpan, Palo Alto, CA (US); Yao Lu, Palo Alto, CA (US); Tianhe Yu, Mountain View, CA (US); Aviral Kumar, Berkeley, CA (US); Karl Ludwig Pertsch, Los Angeles, CA (US); Alexander Herzog, Moraga, CA (US); Keerthana P G, San Francisco, CA (US); Julian Ibarz, Sunnyvale,, CA (US); Ofir Nachum, San Francisco, CA (US); Kanury Kanishka Rao, Santa Clara, CA (US); Chelsea Breanna Finn, Berkeley, CA (US); Sergey Vladimir Levine, Berkeley, CA (US)

(21) Appl. No.: 19/153,532

(22) PCT Filed: Feb. 5, 2024
(86) PCT No.: PCT/US2024/014415

§ 371 Date: Aug. 4, 2025

Related U.S. Application Data
(60) Provisional application No. 63/443,366, filed on Feb. 3, 2023.

(51) Int. Cl. G06N 3/045; G06N 3/092; G06V 10/764; G06V 10/77; G06V 10/774; G06V 10/82; G06V 20/50; G06V 20/70

(52) U.S. Cl. CPC G06N 3/045; G06N 3/092; G06V 10/764; G06V 10/7715; G06V 10/774; G06V 10/82; G06V 20/50; G06V 20/70

(57) ABSTRACT

Methods, systems, and apparatus, including computer programs encoded on a computer storage medium, for controlling an agent interacting with an environment using a Transformer neural network.

### BACKGROUND

This specification relates to controlling agents using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that controls an agent, e.g., a robot, that is interacting in an environment by selecting actions to be performed by the agent and then causing the agent to perform the actions.

The subject matter described in this specification can be implemented in particular embodiments so as to realize one or more of the following advantages.

This specification describes techniques that provide scalable representations for Q-functions, i.e., functions that generate Q-values for actions given the current observation and one or more previous observations. In particular, by discretizing each action dimension of a given action and representing the Q-value of each action dimension as a separate token, a policy system can apply effective high-capacity sequence modeling techniques for Q-learning, i.e., can use a Transformer neural network (also referred to as “Q-Transformer neural network”) to auto-regressively generate Q-values for sub-actions along different action dimensions. By making use of the Transformer neural network and generating Q-values auto-regressively, the policy system can more effectively control agents, e.g., robots, than other approaches. In other words, the described techniques allow for improved control of a robot, thereby improving the technical field of robotics. Additionally, making use of the Transformer neural network allows the system to effectively incorporate natural language instructions into the input to the neural network, allowing the system to effectively control the agent to perform multiple different tasks, i.e., where the current task is specified by the natural language instruction, using the same Transformer neural network without needing to re-train the Transformer neural network.

Additionally, this specification describes techniques for improving the training of the Transformer neural network in order to further improve the performance of the policy system. For example, the system can train the neural network through offline Q-learning on a large offline dataset collected from multiple different sources, e.g., both expert demonstrations and autonomously collected data, even when data from different sources is mixed quality. “Mixed quality” data refers to a data set that includes a significant number of high quality trajectories, i.e., trajectories where the corresponding task was performed successfully and a high return was received, and a significant number of low quality trajectories, i.e., trajectories where the agent was interacting randomly (and therefore the return for any given task would be low) or where the agent failed to perform the corresponding. This allows the policy system to generalize better to new tasks after training.

As another example, the system can train the Transformer neural network through autoregressive Q-learning and can incorporate conservative regularization to prevent the policy system from over-estimating Q-values for actions that are not well-represented in the training data set, improving the performance of the system after training.

As yet another example, the system can incorporate Monte-Carlo (MC) returns into the training, improving the training efficiency. For example, by incorporating the MC returns, the system can accelerate learning progress during training, particularly when the data set is mixed quality.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example policy system and an example control system.

FIG. 2 is an illustration of an architecture of an example policy system.

FIG. 3 is a flow diagram of an example process for controlling an agent interacting with an environment.

FIG. 4 is a flow diagram of an example process for training a Transformer neural network included in a policy system.

FIG. 5 is an illustration of training the Transformer neural network on an experience tuple.

FIG. 6 shows a quantitative example of the performance gains that can be achieved by using a policy system described in this specification.

Like reference numbers and designations in the various drawings indicate like elements.

### DETAILED DESCRIPTION

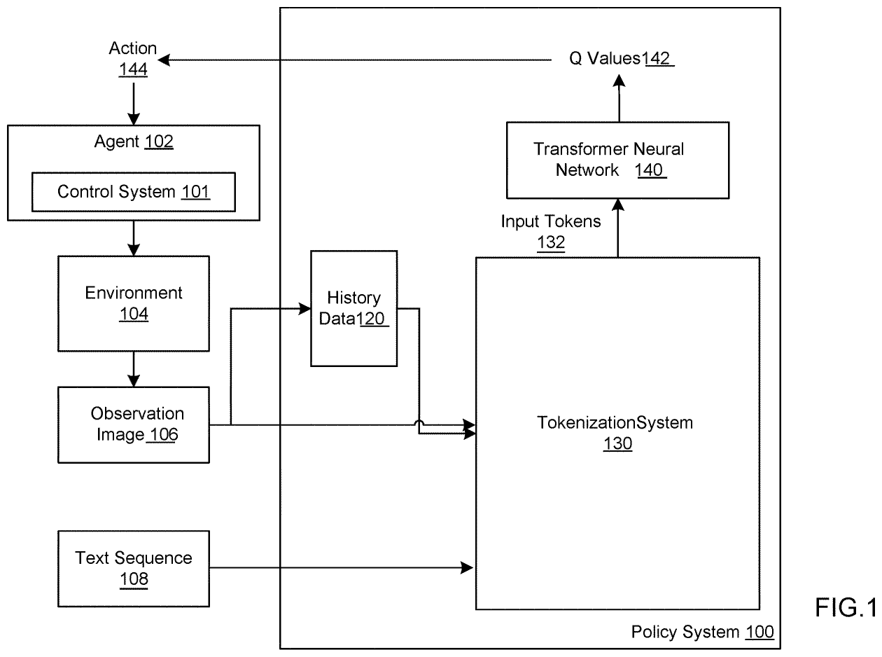

FIG. 1 shows an example policy system 100 and an example control system 101. The policy system 100 and the control system 101 are examples of a system implemented as computer programs on one or more computers in one or more locations in which the systems, components, and techniques described below are implemented.

The policy system 100 and the control system 101 can control an agent 102, e.g., a robot, to accomplish any of a wide variety of tasks in the environment 104. To control the agent 102 that is interacting in the environment 104 to accomplish a task, the policy system 100 selects actions 144 to be performed by the agent 102, and the control system 101 then causes the agent 102 to perform the selected actions 144.

As a general example, the task can include one or more of, e.g., navigating to a specified location in the environment 104, identifying a specific object in the environment 104, manipulating the specific object in a specified way, controlling items of equipment to satisfy criteria, and so on. To accomplish such a task, the agent 102 moves, e.g., navigates and/or changes its configuration, within the environment 104.

Typically, the control system 101 is local to the agent 102. For example, the control system 101 can be on-board the agent 102, e.g., can be implemented on one or more computers, a local workstation, or a local server having relatively small processing and memory resources that is on-board the agent 102.

In some implementations, the policy system 100 is local to the agent 102. For example, like the control system 101, the policy system 100 can also be on-board the agent 102. Moreover, in some of these implementations, the policy system 100 can be a part of the control system 101 which causes the agent 102 to perform actions 144.

In other implementations, the policy system 100 is remote from the agent 102. For example, unlike the control system 101, the policy system 100 can be hosted within a data center, which can be a distributed computing system having hundreds or thousands of computers in one or more locations. That is, the control system 101 can receive data identifying the actions 144 from an external source, e.g., rather than generating such data on-board the agent 102.

In these implementations, the policy system 100 and the control system 101 can be connected by a data communication network, such as a local area network (LAN), a wide area network (WAN), the Internet, or a combination thereof.

In these implementations, the control system 101 of the agent 102 interacts with a remote policy system 100 that is hosted within a data center with much more computing and other resources than those available on-board the agent 102 to reduce the latency in selecting actions 144, reduce the consumption of the limited power supply of the agent 102 when selecting actions 144, or both.

In some implementations, the policy system 100, the control system 101, or both can expose one or more application programming interfaces (APIs) or other data interfaces that facilitate the control of the agent 102. For example, a user of the agent 102 may use an API made available by the action selection system 100 to provide natural language text sequences 108 characterizing the tasks to be performed by the agent. As another example, the policy system 100 and the control system 101 can interact through an API between the two system, e.g., the control system 101 can use the API to provide the observation image 106 to the policy system 100, and the policy system 100 can use the API to provide data specifying the selected actions 144 to the control system 101.

In particular, the policy system 100 and the control system 101 control the agent based on policy outputs generated by a Transformer neural network 140 that has been trained to control the agent in response to observations characterizing the environment and, optionally, natural language instructions 108 characterizing the task to be performed by the agent. The natural language instructions 108 are a natural language text sequence that characterizes a task to be performed by the agent 102 in the environment 104.

For example, the observations can each include one or more observation images 106 captured by a camera sensor of the agent 102 or by a camera sensor located in the environment 104. The camera sensor can for example be a still camera or a video camera.

The natural language text sequences 108 can be received from another agent in the environment 104 or from the control system 101 of the agent 102. For example, another agent in the environment 104 can speak an instruction and the control system 101 or another system can transcribe it into a natural language text sequence 108, and then provide the transcription to the policy system 100. As another example, the control system 101 can receive an instruction, e.g., a text-based input, a selection-based input, or an audio-based input, entered by a user that specifies the natural language text sequence 108, and then provide the instruction to the policy system 100.

More specifically, while controlling the agent, the policy system 100 maintains history data 120 representing observations characterizing states of the environment at preceding time steps. For example, at any given time step, the history data 120 can include data representing the observations at the k most recent time steps, where k is an integer greater than or equal to one. The data representing an observation can include, e.g., the observation itself or a set of one or more tokens that have been generated from the observation.

At each time step, the policy system 100 obtains a current observation characterizing a state of the environment 104 at the time step.

A tokenization system 130 within the system 100 generates, from at least the current observation and the observations represented in the history data 120, an input sequence 132 of input tokens. In particular, the system “tokenizes” the current observation and the observations in the history data 120 so that each observation is represented as one or more tokens and includes these tokens in the input sequence 132.

The system processes the input sequence 132 using the Transformer neural network 140 to select an action 144 to be performed by the agent 102 in response to the current observation.

Generally, the action 144 includes a respective sub-action for each of a plurality of action dimensions in a sequence of action dimensions. The sequence of action dimensions will also be referred to as a “dimension sequence” to distinguish from the input sequence to the Transformer.

More specifically, each action that can be performed by the agent 102 includes a respective sub-action for each of multiple action dimensions. For example, different action dimensions can correspond to different controls of the agent, different coordinates of a given control for the agent, or some combination. For example, the agent may be controlled by specifying the 3D position of the agent or of a controllable element of the agent. In this example, the 3D position can be represented as three action dimensions, one for each of the 3D coordinates. As another example, the agent may be controlled by specifying the 3D orientation of the agent or of a controllable element of the agent. In this example, the 3D orientation can be represented as three action dimensions, one for each of the 3D coordinates. As another example, the agent may be controllable by specifying a closedness of a gripper of the agent. In this example, the gripper closedness can be specified as a single dimension. In some cases, one or more of the action dimensions can correspond to additional actions, e.g., a “no-op” action in which no input is provided to the agent, a “terminate” action that terminates the current task episode and so on.

When some or all of the action dimensions have sub-actions that are continuous, the system can, for each continuous action dimension, discretize the continuous space of sub-actions for the action dimension to generate the candidate set of sub-actions for the action dimension. Discretizing the continuous space allows the action dimension to be effectively modeled by the Transformer neural network 140.

In some implementations, the system 100 represents each action dimension using candidate sets that have the same number of sub-actions, i.e., the same number of “bins.” For example, for continuous action dimensions, the system 100 can discretize all of the continuous action dimensions into the same number of bins. For discrete action dimensions, the system 100 can represent the sub-actions using the fixed number of sub-actions using padding. Using the same number of sub-actions can allow the Transformer neural network 140 to model each action dimension effectively.

As a result, the processing includes, for each of the plurality of action dimensions, processing, using the Transformer neural network 140, a combined sequence that includes the input sequence followed by, for each preceding action dimension that precedes the action dimension in the dimension sequence, the sub-action that was selected for the action dimension to generate a respective Q value 142 for each sub-action in a set of candidate sub-actions for the action dimension.

Thus, for the first action dimension, the combined sequence includes only the input sequence 132 while, for each subsequent action dimension, the combined sequence includes the input sequence followed by one or more preceding sub-actions.

The system 100 then selects a sub-action for the action dimension using the respective Q values for the sub-actions in the set of candidate sub-actions for the action dimension.

That is, the system 100 selects the sub-actions for the action dimensions auto-regressively according to the dimension sequence, so that the sub-action for each action dimension depends on the sub-actions for preceding action dimensions in the dimension sequence.

To select the sub-action for the first action dimension in the sequence, the system 100 processes, using the Transformer neural network 140, the input sequence to generate a respective Q value for each sub-action in a set of candidate sub-actions for the first action dimension and then selects a sub-action for the action dimension using the respective Q values for the candidate sub-actions.

The Q-value for a given candidate sub-action for a given action dimension at a given time step represents an estimate of a return if a corresponding action is performed at the given time step (and actions continue to be selected using the Transformer neural network 140 at subsequent time steps).

Generally, at any given time step, the return that will be received is a combination of the rewards that will be received at time steps that are after the given time step in a task episode or at a predetermined number of time steps after the given time step. For example, at a time step t, the return can satisfy:

$${\sum }_{i} {γ}^{i - t - 1} {r}_{i} ,$$

where i ranges either over all of the time steps after t in the episode or for some fixed number of time steps after t within the episode, γ is a discount factor, and rᵢ is a reward at time step i. As can be seen from the above equation, higher values of the discount factor result in a longer time horizon for the return calculation, i.e., result in rewards from more temporally distant time steps from the time step t being given more weight in the return computation.

Generally, the reward is a scalar numerical value and characterizes a progress of the agent towards completing the task.

As a particular example, the reward can be a sparse binary reward that is zero unless the task is successfully completed and one if the task is successfully completed as a result of the action performed.

As another particular example, the reward can be a dense reward that measures a progress of the agent towards completing the task as of individual observations received during the episode of attempting to perform the task, i.e., so that non-zero rewards can be and frequently are received before the task is successfully completed.

For any given candidate sub-action for the last action dimension, the corresponding action is an action that includes the given candidate sub-action for the last action dimension and, for each preceding action dimension in the dimension sequence, the sub-action that was selected for the action dimension.

For any given candidate sub-action for any given action dimension other than the last action dimension, the corresponding action is an action that includes: (i) for any preceding action dimensions in the dimension sequence, the sub-action that was selected for the action dimension; (ii) for the given action dimension, the given candidate sub-action; and (iii) for each following action dimension in the dimension sequence, a sub-action that would be selected for the action dimension by auto-regressively selecting sub-actions using the Transformer neural network 140 given that the given candidate sub-action is selected for the given action dimension, i.e., the sub-action that would be selected by continuing to select actions using the auto-regressive process described above assuming that the candidate sub-action is selected for the given action dimension.

After having selected the action 144 to be performed by the agent 102 at the time step, the policy system 100 provides data identifying the selected action 144 to the control system 101. In implementations where the policy system 100 is remote from the agent 102, providing the data identifying the selected action 144 can, for example, include transmitting data identifying the selected action 144 over the data communication network that connects the policy system 100 and the control system 101.

The control system 101 then causes the agent 102 to perform the selected action 144. For example, the control system 101 can do this by generating instructions for the agent 102 that when executed will cause the agent 102 to perform the selected action 144, by submitting a control input directly to the appropriate controls of the agent, or by using another appropriate control technique.

In some implementations, the environment 104 is a real-world environment and the agent 102 is a mechanical agent interacting with the real-world environment. For example, the agent may be a robot interacting with the environment to accomplish a goal, e.g., to locate an object of interest in the environment, to move an object of interest to a specified location in the environment, to physically manipulate an object of interest in the environment in a specified way, or to navigate to a specified destination in the environment; or the agent may be an autonomous or semi-autonomous land, air, or sea vehicle navigating through the environment to a specified destination in the environment.

The actions 144 may be control inputs to control a robot, e.g., torques for the joints of the robot or higher-level control commands, or the autonomous or semi-autonomous land or air or sea vehicle, e.g., torques to the control surface or other control elements of the vehicle or higher-level control commands.

In other words, the actions 144 can include for example, position, velocity, or force/torque/acceleration data for one or more joints of a robot or parts of another mechanical agent. Actions may additionally or alternatively include electronic control data such as motor control data, or more generally data for controlling one or more electronic devices within the environment the control of which has an effect on the observed state of the environment. For example in the case of an autonomous or semi-autonomous land, air, or sea vehicle the actions may include actions to control navigation, e.g., steering, and movement e.g., braking and/or acceleration of the vehicle.

In some implementations the environment 104 is a simulated environment and the agent 102 is implemented as one or more computer programs interacting with the simulated environment. For example, the environment can be a computer simulation of a real-world environment and the agent can be a simulated mechanical agent navigating through the computer simulation.

For example, the simulated environment may be a motion simulation environment, e.g., a driving simulation or a flight simulation, and the agent may be a simulated vehicle navigating through the motion simulation. In these implementations, the actions 144 may be control inputs to control the simulated user or simulated vehicle. As another example, the simulated environment may be a computer simulation of a real-world environment and the agent may be a simulated robot interacting with the computer simulation.

Generally, when the environment 104 is a simulated environment, the actions 144 may include simulated versions of one or more of the previously described actions or types of actions.

In some implementations, the environment 104 is a suitable execution environment, e.g., a runtime environment or an operating system environment, that is implemented on one or more computing devices such as smart phones, tablet computers, wearable devices, automobile systems, standalone personal assistant devices, and so forth, and the agent 102 is a virtual agent (also known as “automated assistant” or “mobile assistant”) that may be interacted with by a user through the computing devices. The virtual agent can receive input from the user (e.g., typed or spoken natural language input) and respond with responsive content (e.g., visual and/or audible natural language output). The virtual agent can provide a broad range of functionalities through interactions with various local and/or third-party applications, websites, or other agents. In these implementations, the actions 144 may include any activity or operation that may be performed or initiated by the user on a computing device, e.g., within an application software installed on the computing device.

In some cases, the policy system 100 can be used to control the interactions of the agent with a simulated environment, and the policy system 100 (or another training system) can train the set of neural networks used to control the agent 102 based on the interactions of the agent 102 (or another agent) with the simulated environment to determine trained values of the parameters of the set of neural networks.

After the set of neural networks are trained based on the interactions of the agent 102 (or another agent) with a simulated environment, the trained neural networks can be used by the policy system 100 to control the interactions of a real-world agent with the real-world environment, i.e., to control the agent that was being simulated in the simulated environment.

Training the neural networks based on interactions of an agent with a simulated environment (i.e., instead of a real-world environment) can avoid wear-and-tear on the agent and can reduce the likelihood that, by performing poorly chosen actions, the agent can damage itself or aspects of its environment.

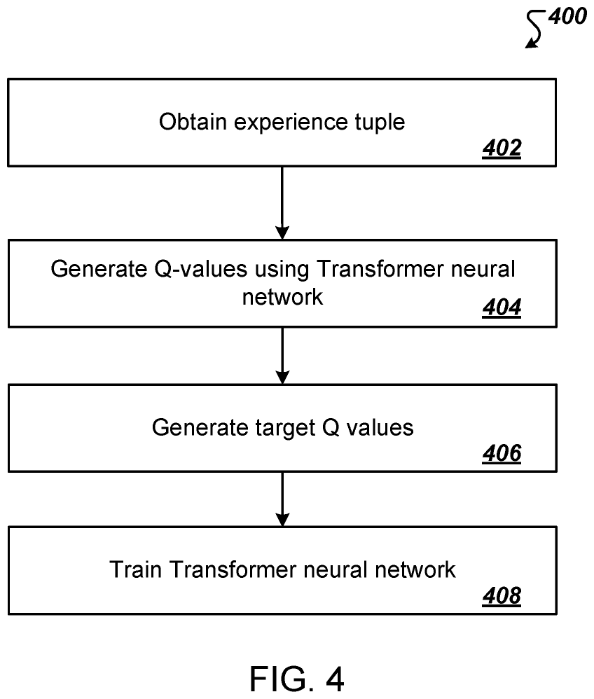

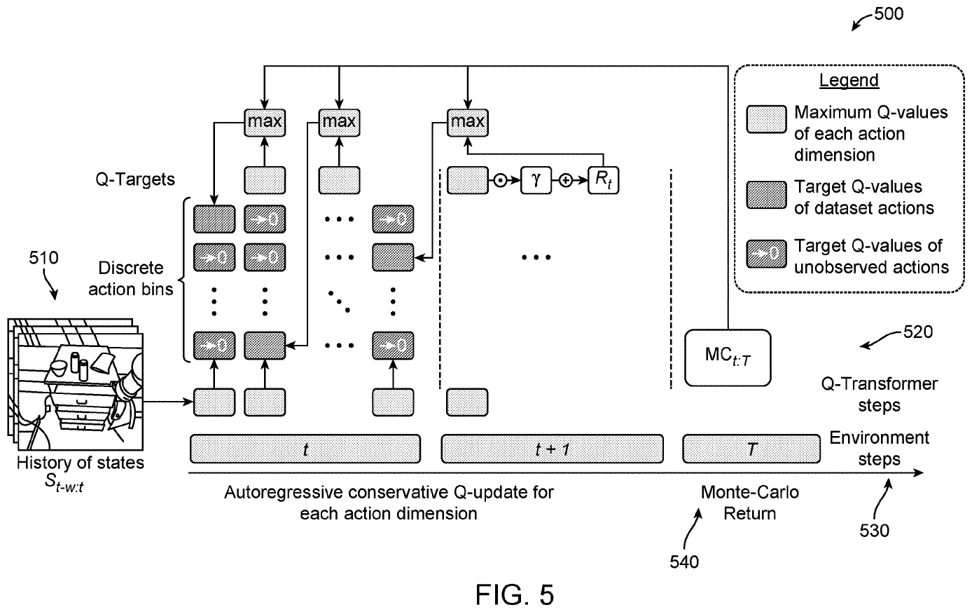

More generally, training the Transformer neural network 140 and, optionally, other neural networks used to generate the input sequence to the Transformer neural network 140, is described in detail below with reference to FIGS. 4 and 5.

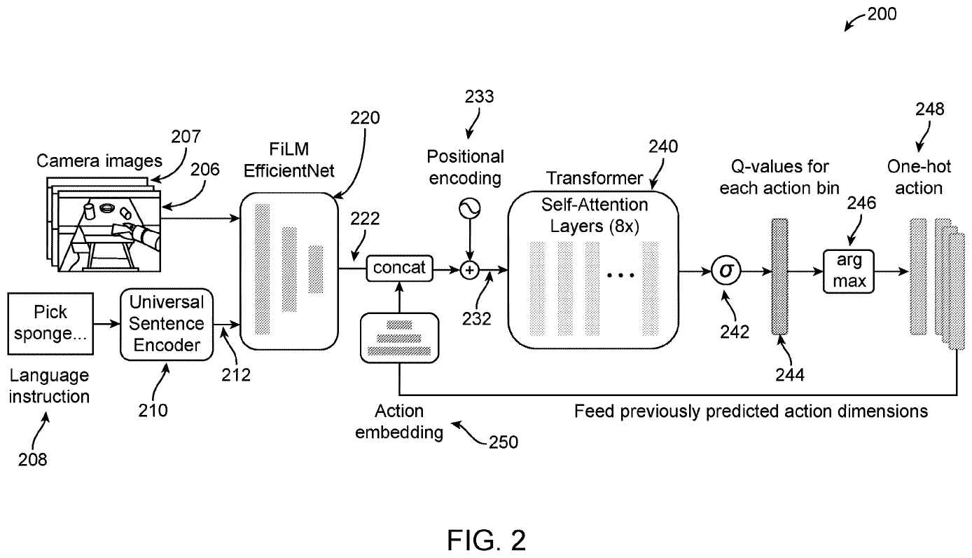

FIG. 2 is an illustration of an architecture of an example policy system 200.

The policy system 200 receives a natural language text sequence 208. The natural language text sequence 208 characterizes a task to be performed by the agent in the environment. The natural language text sequence 208 may have an instructional format. For example, FIG. 2 illustrates that the natural language text sequence 208 is a natural language instruction that describes the task, “Pick sponge . . . ”

The policy system 200 uses a text encoder neural network 210 to process the natural language text sequence 208 to generate an encoded representation 212 of the natural language text sequence.

In the example of FIG. 2, the text encoder neural network 210 has a Universal Sentence Encoder architecture and generates the encoded representation 212 as a single vector, i.e., a vector that include has a fixed number of entries, e.g., 256, 512, or 1024, with each entry being a numerical value, e.g., a floating point value. The Universal Sentence Encoder is described in more detail in Daniel Cer, et al. Universal sentence encoder. arXiv preprint arXiv: 1803.11175, 2018.

In other examples, the text encoder neural network 210 can have a different architecture, and can generate an embedding that has a smaller or larger dimension. Additionally, in other examples, the text encoder neural network 210 can generate an embedding that includes a sequence of multiple embedding vectors.

At each of the plurality of time steps, the policy system 200 obtains an observation image 206 characterizing a state of the environment at the time step. In the example of FIG. 2, the agent performs a single action in response to each observation image 206, e.g., so that a new observation image is obtained by the policy system 200 after each action that the agent performs.

As described above, the policy system 100 also maintains history data 120 representing observations characterizing states of the environment at preceding time steps. In the example of FIG. 2, the system 100 stores observation images 207 at the two immediately preceding time steps in the history data 120.

The policy system 100 uses an image encoder neural network 220 to generate an encoded representation 222 of the observation image 206 and the observation images 207 in the history data. The encoded representation 222 can include a feature map that includes a respective feature vector for each of a plurality of regions in the observation image 206.

In some implementations, the image encoder neural network 220 can generally be configured as a convolutional neural network that includes one or more convolutional layers. As a particular example of this, FIG. 2 illustrates that the image encoder neural network 220 is a convolutional neural network with an EfficientNet architecture that includes a stack of inverted residual blocks (“MBConv blocks”). Inverted residual blocks and the EfficientNet are described in more detail in Mingxing Tan, et al. EfficientNet:

Rethinking model scaling for convolutional neural networks. In Kamalika Chaudhuri and Ruslan Salakhutdinov (eds.), Proceedings of the 36th International Conference on Machine Learning, volume 97 of Proceedings of Machine Learning Research, pp. 6105-6114. PMLR, 09-15 Jun. 2019. URL https://proceedings.mlr.press/v97/tan19a.html.

More generally, the image encoder neural network 220 can have any appropriate neural network architecture, e.g., a convolutional neural network architecture or a vision Transformer neural network architecture.

Moreover, in the example of FIG. 2, the image encoder neural network 220 generates the encoded representation 222 conditioned on the encoded representation 212 of the natural language text sequence. That is, the image encoder neural network 220 receives, as input, the encoded representation 212 of the natural language text sequence and the observation image 206, and processes the input to generate, as output, the encoded representation 222 of the observation images.

The image encoder neural network 220 uses the encoded representation 212 of the natural language text sequence as context when generating the encoded representation 222 of the observation image, i.e., so that different text sequences can result in different representations being generated for the same observation image.

To that end, the image encoder neural network 220 also includes one or more conditioning layers. The conditioning layers can be interleaved between other intermediate layers, e.g., convolutional layers, e.g., depth-wise convolutional layers, attention layers, and so on, of the image encoder neural network 220.

Each conditioning layer receives, as input, (i) a respective intermediate output of a respective intermediate layer of the image encoder neural network and (ii) the encoded representation 212 of the natural language text sequence, and processes the input to (i) update the respective intermediate output of the image encoder neural network using the encoded representation 212 of the natural language instruction and (ii) provide the updated respective intermediate output as input to a respective subsequent intermediate layer of the image encoder neural network.

As a particular example of this, FIG. 2 illustrates that the image encoder neural network 220 includes feature-wise Linear Modulation (FiLM) layers that are interleaved between the stack of inverted residual blocks. A FiLM layer learns functions ƒ and h which output γ and β as a function of input x:

$$γ = f ( x ) ; β = h ( x )$$

where γ and β modulate the respective intermediate output F of the respective intermediate layer through a feature-wise affine transformation:

$$FiLM ( F \vert γ , β ) = γ F + β .$$

The functions ƒ and h may be, but need not be, implemented as neural networks, e.g., multi-layer perceptrons (MLPs) or convolutional neural networks.

A FILM layer is described in more detail in Ethan Perez, et al. Film: Visual reasoning with a general conditioning layer. Proceedings of the AAAI Conference on Artificial Intelligence, 32 (1), April 2018. doi: 10.1609/aaai.v3211.11671.

For example the image encoder neural network 220 can include a FiLM layer arranged between a first inverted residual block and a second inverted residual block in the stack. The FiLM layer receives, as input, (i) a respective intermediate output of the first inverted residual block and (ii) the encoded representation 212 of the natural language text sequence, and processes the input to (i) update the respective intermediate output of the first inverted residual block using the encoded representation 212 of the natural language instruction and (ii) provide the updated respective intermediate output as input to the second inverted residual block. Thus, instead of receiving the respective intermediate output of the first inverted residual block as input, the second inverted residual block receives the updated respective intermediate output that has been updated by the FILM layer using the encoded representation 212 of the natural language text sequence.

The policy system 200 generates, based on the encoded representation 222 of the observation image, a sequence of input tokens 232.

As mentioned above, the encoded representation 222 can include a feature map that includes a respective feature vector for each of a plurality of regions in the observation image 206 or a respective feature map for the observation image 206 and for each of the observation images 207 from the history data 120.

In this example, the policy system 200 generates the input sequence by flattening the feature map(s) into a sequence of feature vectors.

In some other examples, the policy system 200 can generate an initial input sequence by flattening the feature map(s) into a sequence of feature vectors and then process the initial input sequence of feature vectors using a learned module that maps an input sequence to a reduced sequence that includes a smaller number of tokens. TokenLearner is described in more detail in Michael Ryoo, et al. Tokenlearner: Adaptive space-time tokenization for videos. Advances in Neural Information Processing Systems, 34:12786-12797, 2021.

When used, the learned module may be, but need not be, a neural network. When configured as a neural network, the learned module can include any appropriate types of neural network layers (e.g., convolutional layer, fully connected layers, attention layers, pooling layers, and so forth) in any appropriate number (e.g., 1 layer, or 5 layers, or 10 layers) and connected in any appropriate configuration (e.g., as a directed graph of layers).

As a particular example, the learned module can be a TokenLearner neural network module. TokenLearner is described in more detail in Michael Ryoo, et al. Tokenlearner: Adaptive space-time tokenization for videos. Advances in Neural Information Processing Systems, 34:12786-12797, 2021. As another example, the token neural network 130 can have a vision Transformer (ViT) architecture that includes one or more attention layers. As another example, the token neural network 130 can have a convolutional neural network architecture that includes one or more convolutional layers.

In some implementations, to speed up inference by avoiding duplicate computations, the policy system 200 can store the feature vectors included in the input sequence that has been generated at each time step, and reuse them at later time steps That is, the system can store feature vectors for the history observation images at each time step and then use all or a portion of the stored feature vectors when generating

Furthermore, FIG. 2 illustrates that the policy system 200 adopts a positional encoding scheme. Specifically, the policy system 200 adds a respective positional encoding 233 to each token in the input sequence 232 of tokens.

The positional encodings 233 can be determined, e.g., in accordance with a sinusoidal positional encoding scheme, or another encoding scheme, so as to uniquely identify, for each image token, a respective time step from among multiple time steps at which the image token is generated.

The policy system 200 then provides the sequence of input tokens 232 as input to the Transformer neural network 240. As a particular example, FIG. 2 illustrates that the Transformer neural network 240 has a decoder-only Transformer neural network architecture that includes multiple, e.g., 4, 8, 16, or another appropriate number of, self-attention layer blocks. In this example, each self-attention layer block applies a causal self-attention mechanism. For example, each self-attention layer block can uses an attention mask that zeros out attention contributions from future tokens and, optionally, also zeros out actions from previous timesteps. Zeroing out actions from previous timesteps can allow the neural network to be trained on a trajectory that includes transitions for multiple time steps in parallel.

In other examples, the Transformer neural network 240 can have a different Transformer-based architecture, e.g., an encoder-decoder Transformer neural network architecture, that includes more or fewer layers each having the same or different attention mechanisms.

In particular, the policy system 200 uses the Transformer neural network 240 to auto-regressively select an action to be performed by the agent in response to the current observation 206.

In particular, for each action dimension, the system processes, using the Transformer neural network 240, a combined sequence that includes the input sequence followed by, for each preceding action dimension that precedes the action dimension in the dimension sequence, a respective token identifying the sub-action that was selected for the action dimension to generate a respective Q value 242 for each sub-action in a set of candidate sub-actions for the action dimension and then selects a sub-action for the action dimension using the respective Q values for the sub-actions in the set of candidate sub-actions for the action dimension.

In the example of FIG. 2, the system 200 generates the combined sequence for a given action dimension by concatenating an additional token (“action embedding”) 250 to, for the first action dimension, the input sequence of tokens or, for each subsequent action dimension, the combined sequence for the preceding action dimension. The system can generate the additional token by applying a learned embedding function to data identifying the selected sub-action, where the learned embedding function is learned as part of the training of the Transformer neural network.

In particular, to generate the Q values for the sub-actions in the set of sub-actions for the action dimension, the system 200 processes the combined sequence using the self-attention layers and then processes the output of the last self-attention layer using a sigmoid 242 to generate a respective Q-value 244 for each sub-action (“action bin”) and then selects the argmax sub-action 246 according to the respective Q-values. That is, the system selects the candidate sub-action having the highest respective Q-value.

The system then generates a one-hot encoding 248 of the selected sub-action and uses the one-hot encoding to generate the action embedding to be used as part of the combined sequence for the next action dimension.

While FIG. 2 shows an example of generating the input sequence of tokens using an image encoder neural network that uses conditioning layers to condition on the natural language text sequence, more generally, the system can generate the input sequence of tokens from at least the current observation and the observations represented in the history data (and optionally the natural language instruction) in any of a variety of ways.

For example, when there is no natural language sequence, the system can process the current observations and the observations in the history data using an appropriate encoder neural network to generate the input sequence.

As another example, when there is a natural language sequence, the system can process the current observations and the observations in the history data using an appropriate encoder neural network to generate a first sub-sequence and the natural language text sequence using another encoder neural network to generate a second sub-sequence and then concatenate the two sub-sequences to generate the input sequence.

As described above, for the last action dimension in the dimension sequence, the respective Q value for each of the sub-actions in the set of candidate sub-actions for the action dimension represents an estimate of a return that will be received in response the agent performing an action that includes candidate sub-action for the last action dimension and, for each preceding action dimension in the dimension sequence, the sub-action that was selected for the action dimension.

Similarly, for each given candidate sub-action for each given action dimension other than the last action dimension, the respective Q value for the given candidate sub-action represents an estimate of a return that will be received in response to the agent performing an action that includes: (i) for any preceding action dimensions that precede the given action dimension in the dimension sequence, the sub-action that was selected for the action dimension; (ii) for the given action dimension, the candidate sub-action; and (iii) for each following action dimension that follows the given action dimension the dimension sequence, a sub-action that would be selected for the action dimension by auto-regressively selecting sub-actions using the Transformer neural network given that the given candidate sub-action is selected for the given action dimension.

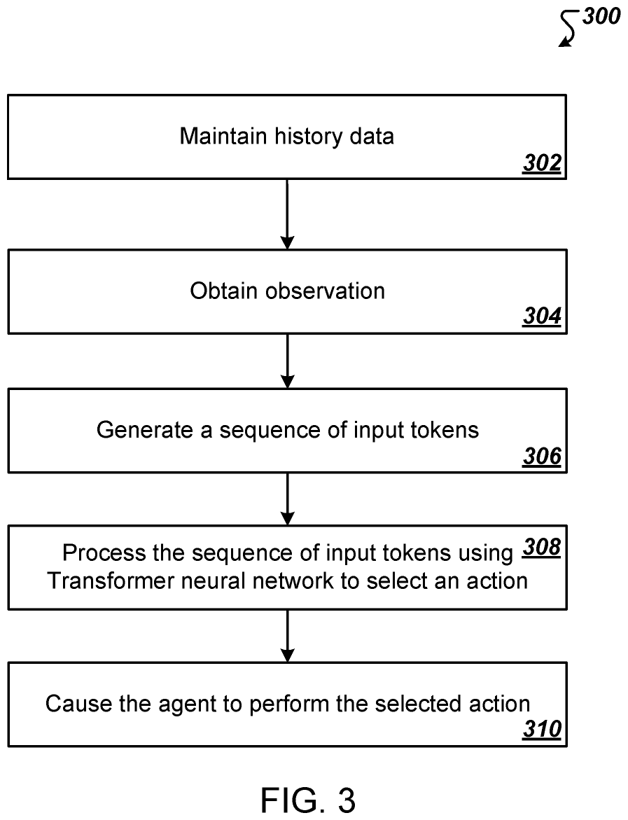

FIG. 3 is a flow diagram of an example process 300 for controlling an agent interacting with an environment. For convenience, the process 300 will be described as being performed by a system of one or more computers located in one or more locations. For example, a policy system, e.g., the policy system 100 of FIG. 1, appropriately programmed in accordance with this specification, can perform the process 300.

The system controls the agent to accomplish a task in the environment by repeatedly performing an iteration of the process 300 at each of a plurality of time steps (referred to below as the “current” time step).

Optionally, the task that will be performed by the agent can be characterized by a natural language text sequence. For example, prior to the first iteration of the process 300, the system receives a natural language text sequence that characterizes a task to be performed by the agent in the environment, and generates an encoded representation of the natural language text sequence. For example, the encoded representation includes an embedding of the natural language text sequence, and the system can generate the embedding by processing the natural language text sequence using a text encoder neural network.

The system maintains history data representing observations characterizing states of the environment at preceding time steps (step 302).

The system obtains an observation characterizing the state of the environment at the current time step (step 304).

The system generates, from at least the current observation and the observations represented in the history data, an input sequence of input tokens (step 306). When the system also receives a natural language text sequence, the system can also generate the input sequence from the embedding of the natural language text sequence.

The system processes the input sequence of input tokens using a Transformer neural network to select an action to be performed by the agent in response to the current observation (step 308).

As described above, the action includes a respective sub-action for each of a plurality of action dimensions in a dimension sequence of action dimensions. To select the action, the system auto-regressively selects the respective sub-actions for the action dimensions in the dimension sequence. That is, for each of the plurality of action dimensions, the system processes, using the Transformer neural network, a combined sequence that includes the input sequence followed by, for each preceding action dimension that precedes the action dimension in the dimension sequence, a respective token identifying the sub-action that was selected for the action dimension to generate a respective Q value for each sub-action in a set of candidate sub-actions for the action dimension and then selects a sub-action for the action dimension using the respective Q values for the sub-actions in the set of candidate sub-actions for the action dimension.

The system then causes the agent to perform the selected action (step 310), e.g., by directly submitting the control input to the agent or by transmitting instructions or other data, e.g., over a data communication network, to a control system for the agent that will cause the agent to perform the selected action.

Some or all of the steps of the process 300 can be performed when controlling an agent to perform a task in which the actions that should be performed, e.g., actions that would result in progression towards accomplishing the task, are not known. Steps of the process 300 can also be performed as part of selecting actions to be performed by an agent based on processing observation images derived from a set of training dataset, i.e., observation images the actions in response to which that should be performed by the agent is known, in order to train the set of neural networks to determine trained values for the parameters of the neural networks.

FIG. 4 is a flow diagram of an example process 400 for training a set of neural networks included in a policy system. For convenience, the process 400 will be described as being performed by a system of one or more computers located in one or more locations. For example, a policy system, e.g., the policy system 100 of FIG. 1, or another training system, appropriately programmed in accordance with this specification, can perform the process 400.

Generally, the system trains the Transformer neural network on a training dataset that includes trajectories of experience tuples.

In some implementations, the system also trains one or more of the other neural networks used by the policy system jointly with the training of the Transformer neural network, e.g., one or more of the image encoder neural network, the text encoder neural network, or the learned module that reduces the number of tokens in the sequence. For any neural network that is not being trained jointly with the training of the Transformer neural network, the system can hold the neural network fixed during the training.

Whether or not they are trained jointly with the Transformer, some or all of the other neural networks can be pre-trained prior to training the Transformer neural network.

In some cases, the text encoder neural network can be pre-trained, e.g., as a part of a larger text processing neural network, on a text processing task, e.g., a text representation learning task, prior to the joint training of the set of neural network. In some of these cases, the text encoder neural network is then fine-tuned during the joint training, while in others of these cases, the text encoder neural network is held frozen during the joint training, i.e., the joint training of neural networks on the training dataset does not adjust the pre-trained parameter values of the pre-trained text encoder neural network.

In some cases, the image encoder neural network can be pre-trained, e.g., as a part of a larger image processing neural network, on an image processing task, e.g., an image classification or segmentation task, and then fine-tuned during the joint training of the set of neural networks on the training dataset.

In some of these cases, the image encoder neural network does not include the one or more conditioning layers for the pre-training (the one or more conditioning layers are added after pre-training). For example, the image encoder neural network can be trained as part of a neural network that is being trained to classify image into a set of categories without conditioning on any natural language text sequence as context.

Moreover, in some of these cases, because inserting the conditioning layers as new layers into such a pre-trained image encoder neural network might cause disruption to the intermediate outputs of the neural network, prior to the joint training, the system initializes each conditioning layer to act as an identity transformation to the corresponding respective intermediate output. This can be done, for example, by setting the at least some of the parameter values associated with each conditioning layer to zeros.

In some cases, the training dataset includes expert interaction data characterizing interactions of one or more expert agents with a corresponding environment. An expert agent can be any agent that selects actions in response to observation images in accordance with an action selection policy that cause the expert agent to make effective progress towards accomplishing a task. For example, the expert agent may be an agent controlled by another already trained policy system, a person who is skilled at the task to be performed by the agent, and so forth.

In some of these cases, the expert interaction data includes simulation data, where a simulated expert agent performs one or more tasks in a simulated environment. In others of these, the expert interaction data includes real-world data, where a real-world expert agent performs one or more tasks in a real-world environment. In yet other cases, the expert interaction data includes both simulation data and real-world data.

In some cases, the training dataset includes training examples that are generated from one or more robots of the same model (and therefore have identical physical characteristics), e.g., when they were performing the same or different tasks, e.g., one of the tasks mentioned above in Table 1, or other tasks.

In other cases, the training dataset can be a mixed training dataset that includes training examples generated from multiple robots that are not the same model, located at the same site, or even built by the same manufacturer. For example, the mixed training data can be generated from tens or hundreds of different robots having different physical characteristics and being different models. In addition, the mixed training data does not need to be generated from physical robots. For example, the mixed training data can include data generated from simulations of physical robots.

The system obtains an experience tuple (step 402).

The experience tuple includes (i) data representing a set of history observations, (ii) a training observation, (iii) a training action performed in response to the training observation, (iv) a reward received in response to the training action being performed, and (v) a next observation that was received in response to the training action being performed.

For example, when the Transformer neural network is being trained using offline Q-learning, the training action can have been performed in response to the training observation by a different agent, e.g., an expert agent or another agent that was being trained.

Generally, the experience tuple is drawn from a trajectory of experience tuples that includes a sequence of multiple experience tuples generated while an agent interacts with an environment.

The system then trains the Transformer neural network on the experience tuple.

As part of training the Transformer neural network, the system generates, using the Transformer neural network and in accordance with the current values of the parameters of the Transformer neural network, a respective Q value for each candidate sub-action for each action dimension given the training observation and the history observations (step 404).

In particular, because of the causal masking of the self-attention layer blocks within the Transformer, the system can generate the respective Q values for all of the candidate sub-actions for all of the action dimensions in parallel, i.e., in one forward pass through the Transformer neural network.

The system then generates, for each action dimension and using the reward in the experience tuple, a respective target Q value for the sub-action that is in the training action for the action dimension (step 406).

Generally, the system can determine the respective target Q values for each of the action dimensions by applying autoregressive Q-target maximization using a corresponding input sequence. Applying autoregressive Q-target maximization refers for a given input sequence refers to processing the input sequence using the Transformer neural network to generate a respective Q value for each sub-action for

In particular, for the last action dimension, the system determines a first target Q value by applying autoregressive Q-target maximization on an input sequence generated from at least (i) one or more of the history observations, (ii) the training observation, and (iii) the next observation.

For example, applying autoregressive Q-target maximization on the input sequence can include selecting an action by processing the input sequence using the Transformer neural network as described above with the parameter values set to target values, e.g., values that are constrained to change more slowly during training than the current values. For example, the target values can be maintained as an exponential moving average (EMA) of the actual training throughout training.

Thus, for the last action dimension, the first target Q value can be equal to a Q value assigned to the selected action (optionally multiplied by a discount factor) plus the reward that is in the tuple.

For any given action dimension other than the last action dimension, the system determines the maximum Q value assigned to any sub-action in the next action dimension by processing, using the Transformer neural network, an input sequence that includes, for any preceding action dimensions in the dimension sequence and for the given action dimension, the corresponding sub-action from the training action and uses this as the first target Q value. For example, the system can determine this maximum Q value in accordance with the target values of the network parameters.

As a particular example, the first target Q value for action dimension i at time step t given the current observation sₜ and history observations for time steps between time step t and time step t−w can be computed as:

$$\{ \begin{matrix}{max}_{{a}_{t}^{i + 1}} Q ( {s}_{t - w : t} , {a}_{t}^{1 : i} , {a}_{t}^{i + 1} ) & if i ∈ \{ 1 , … , {d}_{A} - 1 \} \\ R ( {s}_{t} , {a}_{t} ) + γ {max}_{{a}_{t + 1}^{1}} Q ( {s}_{t - w + 1 : t + 1} , {a}_{t + 1}^{1} ) & if i = {d}_{A}\end{matrix}$$

where

$${a}_{t}^{i + 1}$$

refers to a sub-action for action dimension i+1 at time step t,

$${a}_{t}^{1 : i}$$

refers to the sub-actions in the training action aₜ for time step t for action dimensions 1 through i,

$${a}_{t + 1}^{1}$$

refers to a sub-action for action dimension 1 at time step t+1, d_{A} is the total number of action dimensions, γ is the discount factor, R(sₜ, aₜ) is the reward at time step t (also referred to as Rₜ, i.e., the reward in the experience tuple, s_{t-w:t} is the set of observations from time step t−w to time step t, s_{t-w+1:t+1} is the set of observations from time step t−w+1 to time step t+1,

$$Q ( {s}_{t - w : t} , {a}_{t}^{1 : i} , {a}_{t}^{i + 1} )$$

refers to the Q value generated by the Transformer neural network by processing an input sequence generated for

$${a}_{t}^{i + 1}$$

by processing an input sequence generated from s_{t-w:t} and

$${a}_{t}^{1 : i} ,$$

and

$$Q ( {s}_{t - w + 1 : t + 1} , {a}_{t + 1}^{1} )$$

refers to the Q value generated by the Transformer neural network for

$${a}_{t + 1}^{1}$$

generated from s_{t-w+1:t+1}.

In some implementations, the system uses the first target Q value as the target Q value for the action dimension.

In some other implementations, the system also determines a second target Q value as a Monte Carlo return starting from the reward in the tuple. The Monte Carlo return is a time-discounted sum of rewards received during the trajectory to which the experience tuple belongs starting from the reward in the tuple.

The system can then generate the target Q value for the dimension as a maximum of the first and second target Q values.

The system trains the Transformer neural network on an objective that measures, for each action dimension, a temporal difference error between the respective Q value for the sub-action in the training action for the dimension and the target Q value for the sub-action in the training action for the dimension (step 408).

In some implementations, the objective also encourages, for each action dimension, the respective Q values for sub-actions that are not in the training action for the dimension to be equal to zero. For example, when the Transformer neural network is being trained using off-line learning, including this “conservative” term can improve training by preventing the Transformer neural network from over-estimating Q-values for actions that are not present (or are infrequently present) in the training data set.

For example, the objective can include a term that measures, for each action dimension, a square of a Q value assigned to at least one of the sub-actions that are not in the training action for the dimension.

As a particular example of this, the system can sample an action based on probabilities generated using the behavior policy used to generate the experience tuple, with actions being assigned higher likelihoods by the behavior policy being assigned lower probabilities. The “conservative” term can then measure, for each action dimension of the selected action, a square of a Q value assigned to the sub-action in the sampled action for the dimension (effectively encouraging the Q value to be zero).

As another example of this, the system can approximate the behavior policy by, for each action dimension, taking the average of the squares of the Q values assigned to all of the sub-actions that are not in the training action for the dimension.

As described above, in some implementations, the other neural networks used to generate the input sequence to the Transformer neural network are pre-trained and held fixed during the training of the Transformer neural network. In some other implementations, the system also trains one or more of the neural networks, e.g., by backpropagating gradients of the objective through the Transformer neural network.

While FIG. 4 describes the system training the Transformer neural network on a single tuple, in practice, at each iteration of the process 400, the system can train the Transformer neural network on a set of multiple experience tuples, e.g., on multiple experience tuples from the same trajectory or on different tuples sampled from different trajectories. In this case, the overall objective can be an average or weighted average of the objectives for each of the tuples.

FIG. 5 shows an example 500 of the training of the Transformer neural network on an experience tuple for time step t that includes data representing a set of history observations and a current observation (which are jointly denoted as s_{t-w:t} in the Figure).

For each action dimension, the sub-action that was included in the training action in the experience tuple is designated with a plain black box in the Figure.

As described above, for each sub-action that was included in the training action, the objective measures a temporal difference error between the respective Q value for the sub-action in the training action for the dimension and the respective target Q value (“Q-Targets”) for the sub-action in the training action for the dimension.

As shown in FIG. 5, the system uses a conservative Q-update for each action dimension, with the objective encouraging, for each action dimension, the respective Q values for sub-actions that are not in the training action for the dimension (i.e., the boxes that include the “→0” designation) to be equal to zero.

As shown in the Figure, to compute the target Q value for a given action dimension, the system determines a first target Q value by applying autoregressive Q-target maximization using a corresponding input sequence. This is done as described above with reference to FIG. 4, with the first target Q values being computed differently for the last action dimension (using Rₜ) than for the preceding action dimensions.

The system also determines a second target Q value as a Monte Carlo return (MC_{t:T}) 540 starting from the reward in the tuple. As described above, the Monte Carlo return is a time-discounted sum of rewards (discounted by the discount factor γ as described above) received during the trajectory to which the experience tuple belongs starting from the reward in the tuple. For example, the MC return can be computed using respective rewards from time step t to time step T, which can be a time step a fixed number of time steps into the future relative to time step t or the last time step in the trajectory.

For each action dimension, the system can then generate the target Q value as a maximum of the first and second target Q values for the action dimension.

As can be seen from FIG. 5, because of the auto-regressive generation of the actions (and auto-regressive computation of target Q values), there are many Q-Transformer steps 520 for every environment step (“time step”) 530.

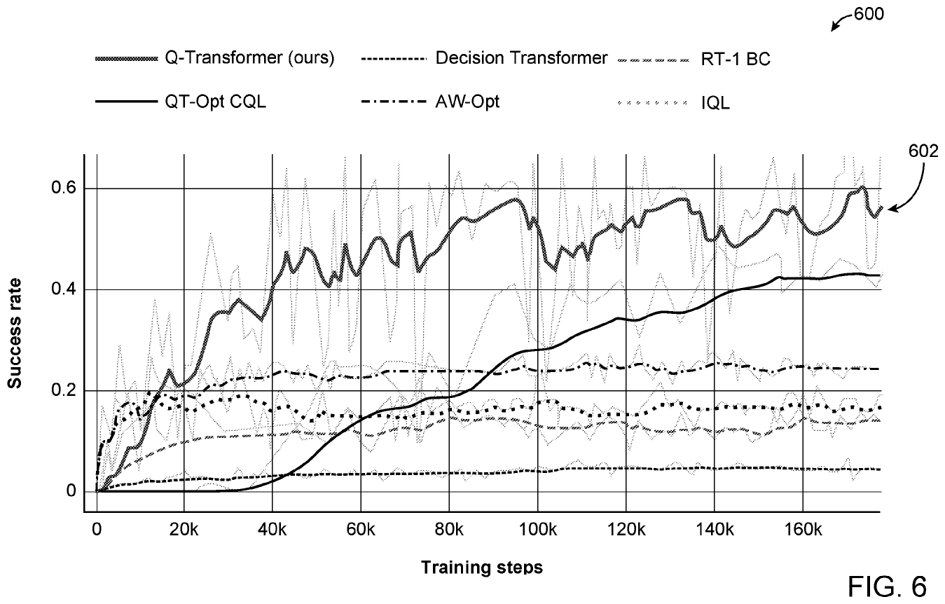

FIG. 6 shows a quantitative example of the performance gains that can be achieved by using a policy system described in this specification.

Specifically, FIG. 6 shows overall performance of an agent (in term of success rate after various numbers of training steps) controlled using the policy 100 of FIG. 1 (“Q-Transformer”) 602 and agents controlled using baseline systems on a robotics task that requires picking up and moving specified objects using observation images.

The baseline systems include a QT-Opt CQL system, a Decision Transformer system, an AW-Opt system, an IQL system, and a RT-1 BC system.

It can be appreciated that Q-Transformer outperforms these baseline systems by large margins at almost all numbers of training steps. In particular, as training progresses past the first 20,000 training steps, the Q-Transformer is significantly improved in terms of success rate relative to all baselines across all remaining training steps.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

This specification also provides the subject-matter of the following clauses:

Clause 1. A method performed by one or more computers and for controlling an agent interacting with an environment, the method comprising, at each of a plurality of time steps:
maintaining history data representing observations characterizing states of the environment at preceding time steps;
obtaining a current observation characterizing a state of the environment at the time step;
generating, from at least the current observation and the observations represented in the history data, an input sequence of input tokens;
processing the input sequence of input tokens using a Transformer neural network to select an action to be performed by the agent in response to the current observation, wherein the action comprises a respective sub-action for each of a plurality of action dimensions in a dimension sequence of action dimensions, and wherein the processing comprises, for each of the plurality of action dimensions:
   processing, using the Transformer neural network, a combined sequence that includes the input sequence followed by, for each preceding action dimension that precedes the action dimension in the dimension sequence, a respective token identifying the sub-action that was selected for the action dimension to generate a respective Q value for each sub-action in a set of candidate sub-actions for the action dimension; and
   selecting a sub-action for the action dimension using the respective Q values for the sub-actions in the set of candidate sub-actions for the action dimension; and
causing the agent to perform the selected action.

Clause 2. The method of clause 1, wherein the environment is a real-world environment and the agent is a robot.

Clause 3. The method of clause 1 or clause 2, wherein, for one or more of the action dimensions, the set of candidate sub-actions for the action dimension represents a discretization of a continuous space of sub-actions for the action dimension.

Clause 4. The method of any preceding clause, further comprising:
prior to the first time step of the plurality of time steps, receiving a natural language text sequence that characterizes a task to be performed by the agent in the environment, wherein generating, from at least the current observation and the observations represented in the history data, an input sequence of input tokens, comprises:
generating the input sequence from at least the current observation, the observations represented in the history data, and the natural language text sequence.

Clause 5. The method of any preceding clause, wherein the current observation and the observations in the history data each comprise one or more images of the environment.

Clause 6. The method of clause 5, when dependent on clause 4, further comprising:
processing the current observation using an image encoder neural network that is conditioned on an encoded representation of the natural language text sequence to generate an encoded representation of the current observation, wherein generating the input sequence from at least the current observation, the observations represented in the history data, and the natural language text sequence comprises:
generating, from at least the encoded representation of the current observation and respective encoded representation of the observations in the history, the input sequence of input tokens.

Clause 7. The method of clause 6, wherein generating, from at least the encoded representation of the current observation and respective encoded representation of the observations in the history, the input sequence of input tokens comprises:
generating, from the encoded representation of the current observation, a sequence of image tokens for the current observation.

Clause 8. The method of clause 7, wherein the input sequence of input tokens comprises the sequence of image tokens for the current observation and respective sequence of image tokens for each of the observations in the history that has been generated from the respective encoded representation of the observation.

Clause 9. The method of clause 8, wherein position encodings are applied each image token in the sequence of image tokens for the observation image and the respective sequences of image tokens for the one or more earlier observations.

Clause 10. The method of any one of clauses 6-9, wherein the encoded representation comprises a feature map that includes a respective feature vector for each of a plurality of regions in the current observation, and wherein generating, from the encoded representation of the observation, a sequence of image tokens for the observation image comprises:
generating an initial input sequence by flattening the feature map into a sequence of feature vectors.

Clause 11. The method of clause 10, wherein generating, from the encoded representation of the observation, a sequence of image tokens for the observation image comprises:
processing the initial input sequence of feature vectors using a learned module that maps an input sequence to a reduced sequence that includes a smaller number of tokens.

Clause 12. The method of any one of clauses 6-11, wherein the image encoder neural network comprises one or more conditioning layers that are each configured to receive a respective intermediate output of a respective intermediate layer of the image encoder neural network output and the encoded representation of the natural language instruction and to (i) update the respective intermediate output of the image encoder neural network using the encoded representation of the natural language instruction and (ii) provide the updated respective intermediate output as input to a respective subsequent intermediate layer of the image encoder neural network.

Clause 13. The method of clause 12, wherein the one or more conditioning layers are feature-wise Linear Modulation (FiLM) layers.

Clause 14. The method of any one of clauses 12 or 13, wherein the image encoder neural network is a convolutional neural network and the respective intermediate layer, the respective subsequent layer, or both are convolutional layers.

Clause 15. The method of any preceding clause, wherein the Transformer is a decoder-only Transformer comprising a plurality of self-attention layer blocks.

Clause 16. The method of any preceding clause, wherein selecting a sub-action for the action dimension comprises:
selecting the candidate sub-action having the highest respective Q-value.

Clause 17. The method of any preceding clause when dependent on clause 6, wherein the image encoder neural network and the Transformer neural network have been trained jointly on a set of training data.

Clause 18. The method of clause 17, wherein, prior to the joint training, the image encoder neural network has been pre-trained on an image classification task.

Clause 19. The method of clause 18, when dependent on clause 12, wherein the image encoder neural network does not include the one or more conditioning layers for the pre-training.

Clause 20. The method of any one of clauses 17-19 when dependent on clause 11, wherein each conditioning layer is, prior to the joint training, initialized to act as an identity transformation to the corresponding respective intermediate output.

Clause 21. The method of any one of clauses 17-20 when dependent on clause 11, wherein the learned module has also been trained as part of the joint training.

Clause 22. The method of any one of clauses 17-21, wherein the training data includes simulation data.

Clause 23. The method of any one of clauses 17-22, wherein the training data includes real-world data.

Clause 24. The method of clause 23, wherein the training data includes both simulation data and real-world data.

Clause 25. The method of any preceding clause when dependent on clause 6, further comprising: generating the encoded representation of the natural language text sequence by processing the natural language text sequence using a text encoder neural network to generate an embedding of the encoded representation.

Clause 26. The method of clause 25, wherein the text encoder neural network is pre-trained on a text representation learning task.

Clause 27. The method of clause 26, when dependent on clause 17, wherein the text encoder neural network is fine-tuned during the joint training.

Clause 28. The method of clause 26, when dependent on clause 17, wherein the text encoder neural network is held frozen during the joint training.

Clause 29. The method of any preceding clause, wherein the Transformer has been trained on an off-line data set through off-line reinforcement learning.

Clause 30. The method of clause 29, wherein the Transformer has been trained on the off-line data set through off-line Q-learning.

Clause 31. The method of clause 30, wherein the off-line Q-learning is a conservative off-line Q-learning technique.

Clause 32. The method of any preceding clause, wherein for the last action dimension in the dimension sequence, the respective Q value for each of the sub-actions in the set of candidate sub-actions for the action dimension represents an estimate of a return that will be received in response the agent performing an action that includes candidate sub-action for the last action dimension and, for each preceding action dimension in the dimension sequence, the sub-action that was selected for the action dimension.

Clause 33. The method of any preceding clause, wherein for each given candidate sub-action for each given action dimension other than the last action dimension, the respective Q value for the given candidate sub-action represents an estimate of a return that will be received in response to the agent performing an action that includes:
for any preceding action dimensions that precede the given action dimension in the dimension sequence, the sub-action that was selected for the action dimension;
for the given action dimension, the candidate sub-action; and
for each following action dimension that follows the given action dimension the dimension sequence, a sub-action that would be selected for the action dimension by auto-regressively selecting sub-actions using the Transformer neural network given that the given candidate sub-action is selected for the given action dimension.

Clause 34. The method of any preceding clause, wherein the agent is a robot and the one or more computers are on-board the robot.

Clause 35. The method of any preceding clause when dependent on clause 15, wherein the each self-attention layer block applies a causal self-attention mechanism.

Clause 36. A method of controlling a robot, the method comprising, at each of a plurality of time steps:
obtaining, by a control system of the robot, an observation image of the environment at the time step;
providing, by a control system of the robot, the observation image to a policy system;
obtaining, by the control system of the robot and from the policy system of the robot, data specifying a selected action, wherein the policy system selects the selected action in response to the observation image by performing the operations of the respective method of any preceding clause; and
causing, by the control system of the robot, the robot to perform the selected action.

Clause 37. The method of clause 36, wherein the control system of the robot is on-board the robot.

Clause 38. The method of clause 37, wherein the policy system is on-board the robot.

Clause 39. The method of clause 37, wherein:
the policy system is remote from the robot,
providing the observation image comprises transmitting the observation image over a data communication network; and
obtaining the data specifying the selected action comprises receiving the data specifying the selected action over the data communication network.

Clause 40. A method of training the Transformer neural network of any preceding clause, the method comprising:
obtaining an experience tuple comprising (i) data representing a set of history observations, (ii) a training observation, (iii) a training action performed in response to the training observation, (iv) a reward received in response the action being performed, and (v) a next observation; and
training the Transformer neural network on the experience tuple, comprising:
   generating, using the Transformer neural network and in accordance with the current values of the parameters of the Transformer neural network, a respective Q value for each candidate sub-action for each action dimension given the training observation and the history observations;
   generating, for each action dimension and using the reward in the experience tuple, a respective target Q value for the sub-action that is in the training action for the action dimension; and
   training the Transformer neural network on an objective that measures, for each action dimension, a temporal difference error between the respective Q value for the sub-action in the training action for the dimension and the target Q value for the sub-action in the training action for the dimension.

Clause 41. The method of clause 40, wherein the objective encourages, for each action dimension, the respective Q values for sub-actions that are not in the training action for the dimension to be equal to zero.

Clause 42. The method clause 41, wherein the objective measures, for each action dimension, a square of a Q value assigned to at least one of the sub-actions that are not in the training action for the dimension.

Clause 43. The method of any one of clauses 40-42, wherein generating, for each action dimension and using the reward in the experience tuple, a respective target Q value for the sub-action that is in the training action for the action dimension:
determining a first target Q value by applying autoregressive Q-target maximization on an input sequence generated from at least (i) one or more of the history observations, (ii) the training observation, and (iii) the next observation.

Clause 44. The method of clause 43, wherein applying autoregressive Q-target maximization on the input sequence comprises selecting an action by processing the input sequence using the Transformer neural network as described above in any one of clauses 1-35 with the parameter values set to target values.

Clause 45. The method of any one of clauses 43 or 44, further comprising:
determining a second target Q value as a Monte Carlo return starting from the reward in the tuple; and
generating the target Q value using the reward in the experience tuple and a maximum of the first and second target Q values.

Clause 46. The method of any one of clauses 40-45, wherein training the Transformer neural network further comprises training the image encoder neural network, the learned module, or both.

Clause 47. A system comprising one or more computers and one or more storage devices storing instructions that when executed by the one or more computers cause the one more computers to perform the operations of the respective method of any one of clauses 1-46.

Clause 48. One or more computer storage media storing instructions that when executed by one or more computers cause the one more computers to perform the operations of the respective method of any one of clauses 1-46.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers and for controlling an agent interacting with an environment, the method comprising, at each of a plurality of time steps:
maintaining history data representing observations characterizing states of the environment at preceding time steps;
obtaining a current observation characterizing a state of the environment at the time step;
generating, from at least the current observation and the observations represented in the history data, an input sequence of input tokens;
processing the input sequence of input tokens using a Transformer neural network to select an action to be performed by the agent in response to the current observation, wherein the action comprises a respective sub-action for each of a plurality of action dimensions in a dimension sequence of action dimensions, and wherein the processing comprises, for each of the plurality of action dimensions:
processing, using the Transformer neural network, a combined sequence that includes the input sequence followed by, for each preceding action dimension that precedes the action dimension in the dimension sequence, a respective token identifying the sub-action that was selected for the action dimension to generate a respective Q value for each sub-action in a set of candidate sub-actions for the action dimension; and
selecting a sub-action for the action dimension using the respective Q values for the sub-actions in the set of candidate sub-actions for the action dimension; and
causing the agent to perform the selected action.

2. The method of claim 1, wherein the environment is a real-world environment and the agent is a robot.

3. The method of claim 1, wherein, for one or more of the action dimensions, the set of candidate sub-actions for the action dimension represents a discretization of a continuous space of sub-actions for the action dimension.

4. The method of claim 1, further comprising:
prior to the first time step of the plurality of time steps, receiving a natural language text sequence that characterizes a task to be performed by the agent in the environment, wherein generating, from at least the current observation and the observations represented in the history data, an input sequence of input tokens, comprises:
generating the input sequence from at least the current observation, the observations represented in the history data, and the natural language text sequence.

5. The method of claim 1.

6. The method of claim 4, wherein the current observation and the observations in the history data each comprise one or more images of the environment, and further comprising:
processing the current observation using an image encoder neural network that is conditioned on an encoded representation of the natural language text sequence to generate an encoded representation of the current observation, wherein generating the input sequence from at least the current observation, the observations represented in the history data, and the natural language text sequence comprises:
generating, from at least the encoded representation of the current observation and respective encoded representation of the observations in the history, the input sequence of input tokens.

7. The method of claim 6, wherein generating, from at least the encoded representation of the current observation and respective encoded representation of the observations in the history, the input sequence of input tokens comprises:
generating, from the encoded representation of the current observation, a sequence of image tokens for the current observation.

8. The method of claim 7, wherein the input sequence of input tokens comprises the sequence of image tokens for the current observation and respective sequence of image tokens for each of the observations in the history that has been generated from the respective encoded representation of the observation.

9. The method of claim 8, wherein position encodings are applied to each image token in the sequence of image tokens for the observation image and the respective sequences of image tokens for the one or more earlier observations.

10. The method of claim 6, wherein the encoded representation comprises a feature map that includes a respective feature vector for each of a plurality of regions in the current observation, and wherein generating, from the encoded representation of the observation, a sequence of image tokens for the observation image comprises:
generating an initial input sequence by flattening the feature map into a sequence of feature vectors.

11. The method of claim 10, wherein generating, from the encoded representation of the observation, a sequence of image tokens for the observation image comprises:
processing the initial input sequence of feature vectors using a learned module that maps an input sequence to a reduced sequence that includes a smaller number of tokens.

12. The method of claim 6, wherein the image encoder neural network comprises one or more conditioning layers that are each configured to receive a respective intermediate output of a respective intermediate layer of the image encoder neural network output and the encoded representation of the natural language instruction and to (i) update the respective intermediate output of the image encoder neural network using the encoded representation of the natural language instruction and (ii) provide the updated respective intermediate output as input to a respective subsequent intermediate layer of the image encoder neural network.

13. The method of claim 12, wherein the one or more conditioning layers are feature-wise Linear Modulation (FiLM) layers.

14. The method of claim 12, wherein the image encoder neural network is a convolutional neural network and the respective intermediate layer, the respective subsequent layer, or both are convolutional layers.

15. The method of claim 1, wherein the Transformer is a decoder-only Transformer comprising a plurality of self-attention layer blocks.

16. The method of claim 1, wherein selecting a sub-action for the action dimension comprises:
selecting the candidate sub-action having the highest respective Q-value.

17. The method of claim 6, wherein the image encoder neural network and the Transformer neural network have been trained jointly on a set of training data.

18. The method of claim 17, wherein, prior to the joint training, the image encoder neural network has been pre-trained on an image classification task.

19. The method of claim 18, wherein the image encoder neural network comprises one or more conditioning layers that are each configured to receive a respective intermediate output of a respective intermediate layer of the image encoder neural network output and the encoded representation of the natural language instruction and to (i) update the respective intermediate output of the image encoder neural network using the encoded representation of the natural language instruction and (ii) provide the updated respective intermediate output as input to a respective subsequent intermediate layer of the image encoder neural network, and wherein the image encoder neural network does not include the one or more conditioning layers for the pre-training.

20. The method of claim 17, wherein each conditioning layer is, prior to the joint training, initialized to act as an identity transformation to the corresponding respective intermediate output.

21. The method of claim 17, wherein the learned module has also been trained as part of the joint training.

22. (canceled)

23. (canceled)

24. (canceled)

25. The method of claim 6, further comprising: generating the encoded representation of the natural language text sequence by processing the natural language text sequence using a text encoder neural network to generate an embedding of the encoded representation.

26. (canceled)

27. (canceled)

28. (canceled)

29. (canceled)

30. (canceled)

31. (canceled)

32. The method of claim 1, wherein for the last action dimension in the dimension sequence, the respective Q value for each of the sub-actions in the set of candidate sub-actions for the action dimension represents an estimate of a return that will be received in response the agent performing an action that includes candidate sub-action for the last action dimension and, for each preceding action dimension in the dimension sequence, the sub-action that was selected for the action dimension.

33. The method of claim 1, wherein for each given candidate sub-action for each given action dimension other than the last action dimension, the respective Q value for the given candidate sub-action represents an estimate of a return that will be received in response to the agent performing an action that includes:
for any preceding action dimensions that precede the given action dimension in the dimension sequence, the sub-action that was selected for the action dimension;
for the given action dimension, the candidate sub-action; and
for each following action dimension that follows the given action dimension the dimension sequence, a sub-action that would be selected for the action dimension by auto-regressively selecting sub-actions using the Transformer neural network given that the given candidate sub-action is selected for the given action dimension.

34. The method of claim 1, wherein the agent is a robot and the one or more computers are on-board the robot.

35. The method of claim 15, wherein the each self-attention layer block applies a causal self-attention mechanism.

36. A method of controlling a robot, the method comprising, at each of a plurality of time steps:
obtaining, by a control system of the robot, an observation image of the environment at the time step;
providing, by a control system of the robot, the observation image to a policy system;
obtaining, by the control system of the robot and from the policy system of the robot, data specifying a selected action, wherein the policy system selects the selected action in response to the observation image by operations comprising:
maintaining history data representing observations characterizing states of the environment at preceding time steps;
obtaining a current observation characterizing a state of the environment at the time step;
generating, from at least the current observation and the observations represented in the history data, an input sequence of input tokens;
processing the input sequence of input tokens using a Transformer neural network to select an action to be performed by the agent in response to the current observation, wherein the action comprises a respective sub-action for each of a plurality of action dimensions in a dimension sequence of action dimensions, and wherein the processing comprises, for each of the plurality of action dimensions:
processing, using the Transformer neural network, a combined sequence that includes the input sequence followed by, for each preceding action dimension that precedes the action dimension in the dimension sequence, a respective token identifying the sub-action that was selected for the action dimension to generate a respective Q value for each sub-action in a set of candidate sub-actions for the action dimension; and
selecting a sub-action for the action dimension using the respective Q values for the sub-actions in the set of candidate sub-actions for the action dimension; and
causing, by the control system of the robot, the robot to perform the selected action.

37. The method of claim 36, wherein the control system of the robot is on-board the robot.

38. The method of claim 37, wherein the policy system is on-board the robot.

39. The method of claim 37, wherein:
the policy system is remote from the robot,
providing the observation image comprises transmitting the observation image over a data communication network; and
obtaining the data specifying the selected action comprises receiving the data specifying the selected action over the data communication network.

40-46. (canceled)

47. A system comprising one or more computers and one or more storage devices storing instructions that when executed by the one or more computers cause the one more computers to perform operations for controlling an agent interacting with an environment, the operations comprising, at each of a plurality of time steps:
maintaining history data representing observations characterizing states of the environment at preceding time steps;
obtaining a current observation characterizing a state of the environment at the time step;
generating, from at least the current observation and the observations represented in the history data, an input sequence of input tokens;
processing the input sequence of input tokens using a Transformer neural network to select an action to be performed by the agent in response to the current observation, wherein the action comprises a respective sub-action for each of a plurality of action dimensions in a dimension sequence of action dimensions, and wherein the processing comprises, for each of the plurality of action dimensions:
processing, using the Transformer neural network, a combined sequence that includes the input sequence followed by, for each preceding action dimension that precedes the action dimension in the dimension sequence, a respective token identifying the sub-action that was selected for the action dimension to generate a respective Q value for each sub-action in a set of candidate sub-actions for the action dimension; and
selecting a sub-action for the action dimension using the respective Q values for the sub-actions in the set of candidate sub-actions for the action dimension; and
causing the agent to perform the selected action.
